(19) United States
(12) Patent Application Publication
(10) Pub. No.: US 2010/0086063 A1
(43) Pub. Date: Apr. 8, 2010

(54) QUALITY METRICS FOR CODED VIDEO USING JUST NOTICEABLE DIFFERENCE MODELS

(75) Inventors: Barin Geoffry Haskell, Mountain View, CA (US); Xiaojin Shi, Santa Cruz, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/415,340

(22) Filed: Mar. 31, 2009

Related U.S. Application Data
(60) Provisional application No. 61/102,191, filed on Oct. 2, 2008.

(51) Int. Cl. H04N 7/26; H04N 17/00

(52) U.S. Cl. 375/240.27; 348/180; 375/E07.208; 348/E17.001

(57) ABSTRACT

Systems and methods for applying a new quality metric for coding video are provided. The metric, based on the Just Noticeable Difference (JND) distortion visibility model, allows for efficient selection of coding techniques that limit perceptible distortion in the video while still taking into account parameters, such as desired bit rate, that can enhance system performance. Additionally, the unique aspects of each input type, system and display may be considered. Allowing for a programmable minimum viewing distance (MVD) parameter also ensures that the perceptible distortion will not be noticeable at the specified MVD, even though the perceptible distortion may be significant at an alternate distance.

### CROSS-REFERENCE TO RELATED APPLICATIONS

This application claims the benefit of priority from U.S. provisional patent application Ser. No. 61/102,191, filed Oct. 2, 2008, entitled “QUALITY METRICS FOR CODED VIDEO USING JUST NOTICEABLE DIFFERENCE MODELS.” This provisional application is hereby incorporated by reference in its entirety.

### FIELD OF THE INVENTION

The present invention relates generally to the field of video encoding and compression.

### BACKGROUND

Video coding systems are well known. Typically, such systems code a source video sequence into a coded representation that has a smaller bit rate than does the source video and, therefore, achieve data compression. There are a variety of coding modes available to an encoder to be used on a sequence of input data. The quality and compression ratios achieved by such modes can be influenced by the type of image sequences being coded. These various coding modes are lossy processes which can induce distortion in image data once the coded data is decoded and displayed at a receiver.

To estimate distortion, modern coders often estimate a peak signal to noise ratio (PSNR). An image may be coded according to a candidate coding mode and decoded to obtain a replica image. The replica image is compared to the source image and a mean squared error analysis is performed. Coding modes that generate the lowest mean squared error are considered to have the lowest distortion.

Unfortunately, the PSNR estimation does not account for user perception. Certain coding processes may generate errors that generate relatively high PSNR value but are not perceived as significant by human viewers. Certain other coding processes may generate errors that have relatively low PSNR values but would be easily perceived by human viewers. Thus, there is no way to achieve constant visual quality based on PSNR. Accordingly, the inventors perceive a need for a better distortion estimation process for use in coding video and selection among a large set of candidate coding modes.

### BRIEF DESCRIPTION OF THE DRAWINGS

The present invention is described herein with reference to the accompanying drawings, similar reference numbers being used to indicate functionally similar elements.

FIG. 1 is a simplified block diagram of an embodiment of a video coder.

FIG. 2 is a simplified block diagram of an embodiment of a video coding engine.

FIG. 3 is a flow chart illustrating an example for coding video data.

### DETAILED DESCRIPTION

Embodiments of the present invention provide a quality metric for video coders that select coding parameters based on the Just Noticeable Difference (JND) distortion visibility model. Given a single pixel block coded according to n different coding techniques, each of the n coded blocks may be evaluated by the JND technique to determine if that coded block, when decoded, contains perceptible distortion. Where imperceptible distortion may be represented as JND=0, coded blocks for which JND≠0 may be disqualified by the video coder from inclusion in the coded video bitstream, and a coded version of the pixel block for which JND=0 may be selected. If multiple coded blocks survive the JND test, other evaluation metrics, such as lowest bit rate or bit rate is less than a maximum level and with the lowest distortion, such as mean square error, may be used to select a block for inclusion in the bitstream.

The JND technique comparatively assesses performance differences among multiple candidate coding techniques during coding of source video. In traditional video quality measurements, pixel blocks coded according to different coding parameters may be assigned a quality metric based on some average of a number of different quality scores. A JND model that predicts whether distortion or artifacts introduced into the video during coding would be visible, or noticeable, to viewers may be more consistent and consequently more reliable. According to the JND technique, the JND value for a coded pixel block may equal 0 if a majority of viewers would not perceive any coding induced distortion in a video signal.

The JND value may be used to determine if a coded video signal is acceptable. However, combining the JND value with another quality metric may additionally be useful for evaluating different coding algorithms or different parameter settings. For example, using a JND value as well as a minimum bit rate metric can be a simple way to compare the quality of coded video signals. In this case, the best signal may be the one with the lowest bit rate for which the JND value also equals 0. Additionally, to compare different algorithms at the same bit rate, the best quality video signal may be the one for which there is no perceptible distortion at a specified minimum viewing distance. Taking into consideration the individual requirements of a video display system, using the JND value as well as any number of various quality metrics to determine a coded video signal for output, may produce the best quality video signal. Depending on the type and number of metrics used in the evaluation, multiple JND calculations may be required.

There are multiple ways to calculate JND values. For example, the JND value may be calculated as presented in Michael Isnardi, Just Noticeable Difference (JND), Sarnoff Corporation, available at http://www.sarnoff.com/research-and-development/video-communications-networking/video/just-noticeable-difference, or Shan Suthaharan, et al., “A New Quality Metric Based On Just-Noticeable Difference, Perceptual Regions, Edge Extraction And Human Vision,” 30 Canadian Journal of Electrical and Computer Engineering, Spring 2005, at 81.

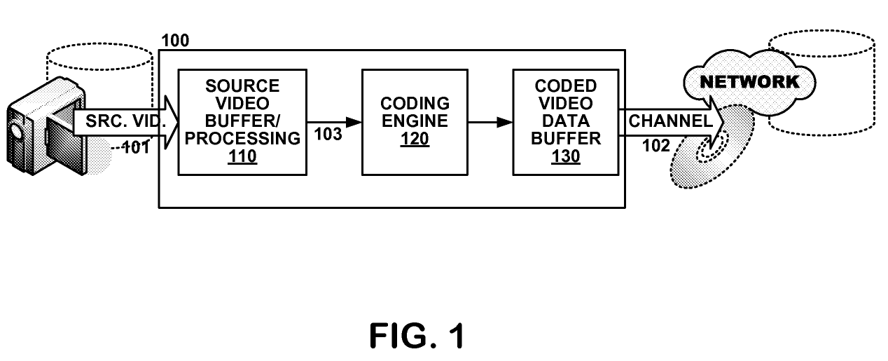

FIG. 1 illustrates an embodiment of a video coder 100. The video coder 100 may receive source video data 101 at an input, potentially from a camera or data storage device. The video coder 100 may generate coded video data, which may be output to a channel 102 for delivery. The output channel 102 may include transmission channels provided by communications or computer networks or storage media such as electrical, magnetic or optical storage devices. Coded video may also be coded and stored for delivery to multiple decoders as is common for on-demand video downloads.

A video coder 100 may select one of a wide variety of coding techniques to code video data, where each different coding technique may yield a different level of compression, depending upon the content of the source video. The video coder 100 may code each portion of the video sequence 101 (for example, each pixel block) according to multiple coding techniques and examine the results to select a preferred coding mode for the respective portion. For example, the video coder 100 might code the pixel block according to a variety of prediction types (e.g., predictive P coding from another reference frame, predictive B coding from a pair of reference frames or spatially predictive coding from another block of the frame currently being coded), decode the coded block and estimate whether distortion induced in the decoded block would be perceptible. Further, the video coder 100 may code the pixel block according to a variety of quantization levels, decode the coded block and estimate whether distortion induced in the decoded block would be perceptible. A variety of coding options are available to modern video coders to code video data according to different levels of perception. For the purposes of the present discussion, all such varieties are compatible with the JND techniques described herein unless otherwise noted.

The video coder 100 may include a source video buffer/pre-processor 110, a coding engine 120 and a coded video data buffer. The source video 101 may be input into the buffer/processing unit 110. The preprocessing buffer 110 may store the input data and may perform pre-processing functions such as parsing frames of the video data into pixel blocks 103. The coding engine 120 may code the processed data according to a variety of coding modes and coding parameters to achieve data compression. The compressed data blocks may be stored by the coded video data buffer 130 where they may be combined into a common bit stream to be delivered by a transmission channel 102 to an end user decoder or for storage. In this regard, the operation of a video coder is well known.

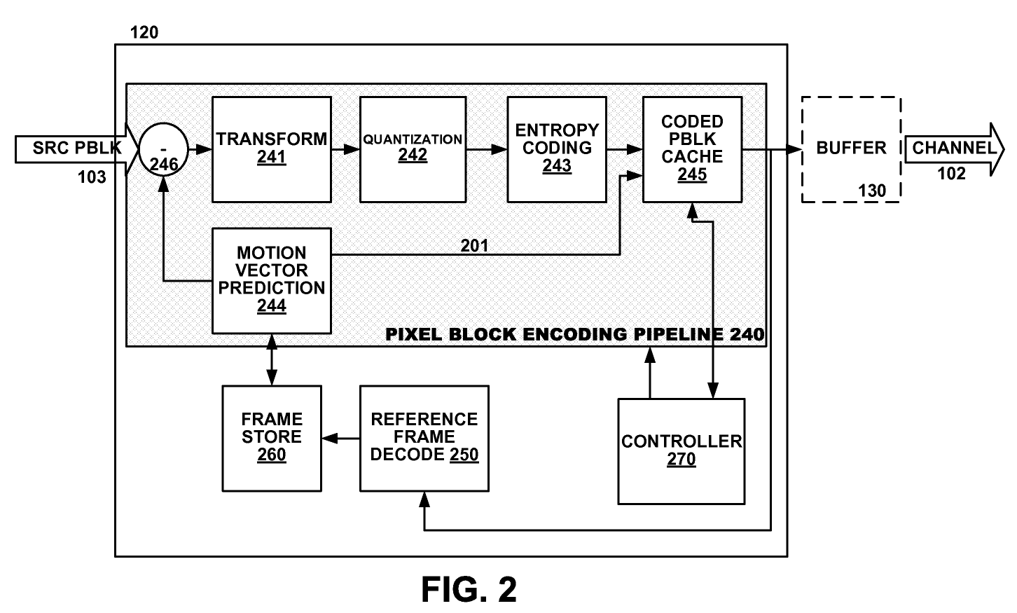

FIG. 2 is a simplified diagram of a coding engine 120 according to an embodiment. The coding engine 120 may include a pixel block encoding pipeline 240 further including a transform unit 241, a quantizer unit 242, an entropy coder 243, a motion vector prediction unit 244, a coded pixel block cache 245, and a subtractor 246. The transform unit 241 converts the incoming pixel block data 103 into an array of transform coefficients, for example, by a discrete cosine transform (DCT) process or wavelet process. The transform coefficients can then be sent to the quantizer unit 242 where they are divided by a quantization parameter. The quantized data may then be sent to the entropy coder 243 where it may be coded by run-value or run-length or similar coding for compression. The coded data can then be sent to the motion vector prediction unit 244 to generate predicted pixel blocks. The motion vector prediction unit 244 may also supply engine parameters 201 such as parameters for prediction type and motion vectors for coding to the channel. The subtractor 246 may compare the incoming pixel block data 103 to the predicted pixel block output from motion vector prediction unit 244, thereby generating data representative of the difference between the two blocks. However, non-predictively coded blocks may be coded without comparison to the reference pixel blocks. The coded pixel blocks may then be temporarily stored in the block cache 245 until they can be output from the encoding pipeline 240.

The coding engine 120 may further include a reference frame decoder 250 that decodes the coded pixel blocks output from the encoding pipeline 240 by reversing the entropy coding, the quantization, and the transforms. The decoded frames may then be stored in a frame store 260 for use with the motion vector prediction unit 244.

As noted, a pixel block may be encoded several times, using various coding techniques, in order to determine the best technique for coding the pixel block. This approach may resemble a trial and error process. Differently coded versions of the same pixel block and related coding parameters, including information about the coding technique used and other relevant data, may be stored in the coded pixel block cache 245 until it can be reviewed by the controller 270 and a desired coded block can be selected and sent to the video data buffer 130. The controller 270 may manage the coding of the source data, estimate the perceptible distortion value of the block upon decoding, and select the final coding mode for the block. Any coded pixel block for which the perceptible distortion value is above a predetermined threshold could be disqualified from transmission. For JND distortion, the predetermined threshold value may be 0.

Optionally, the controller 270 may select for transmission one of the remaining coded pixel blocks according to additional system parameters. For example, the designated additional parameter may be a limit on the decode complexity that the selected coding parameters induce at a decoder (not shown), the resilience of the coded block to transmission bit errors, the minimum viewing distance required for which JND=0, or the lowest bit rate. Additionally, system parameters may change dynamically during run time of the video coder, for example by adding another parameter, altering a predetermined threshold value for the parameter, or using different parameters altogether.

According to an embodiment, for each of the coded blocks, the controller 270 may derive the minimum viewable distance (MVD) at which the perceptible distortion satisfies a predetermined distortion threshold (i.e. JND=0). The controller 270 may compare the pixel block's MVD against a predetermined distance threshold (for example: 3000 times the pixel height). Any cached pixel block having an MVD score greater than the distance threshold may be disqualified from transmission. The controller 270 may select one of the remaining pixel blocks according to a predetermined parameter. Additionally, MVD may be one of many metrics used by the controller 270 to select appropriately coded blocks (i.e. the lowest MVD or MVD less than a threshold value).

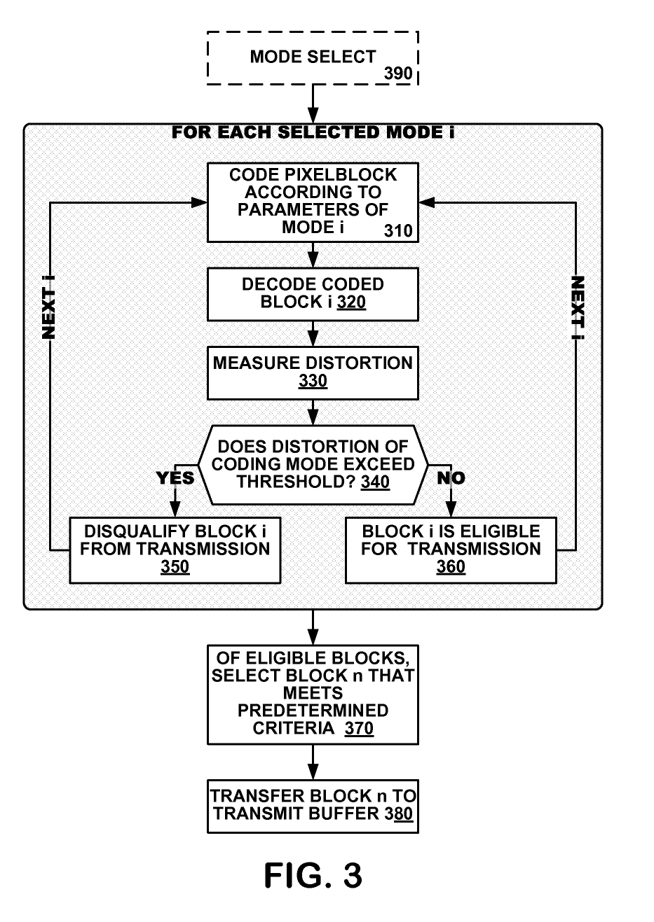

FIG. 3 shows a flow chart for coding the video data according to an embodiment. Given a variety of potential coding modes, a pixel block may be coded in accordance with each potential mode. The pixel block may be first coded at 310 according to parameters appropriate for the respective mode. At 320, having coded the pixel block according to the respective mode, the pixel block may be decoded to generate a replica pixel block. The distortion from the coding process may be measured by comparing the decoded pixel block to the original source pixel block at 330 using a JND analysis. The distortion from the coding mode may then be compared to a predetermined distortion threshold at 340. If the perceptible distortion exceeds the distortion threshold at 340, that coding mode can be declared ineligible for transmission of that pixel block at 350. If the perceptible distortion does not exceed the threshold at 340, the coding mode may remain eligible at 360 for that pixel block. After the coding modes have been performed, a block may be selected for transmission at 370 using a predetermined metric (e.g., lowest bit rate, lowest decoder complexity, lowest MVD score, etc.). The selected block can then be merged with other data in the channel at 380.

In an embodiment, the video coder may optionally include a mode select capability 390 in FIG. 3. Not all coding modes may be appropriate for certain kinds of video data. Rather than perform a brute force coding approach where every conceivable coding mode available to an encoder is attempted on every pixel block, coders may select a sub-set of coding modes to be used on pixel blocks on an individual basis.

The distortion-based video coder described above may additionally be used cooperatively with other selection techniques. For example, a video coder could disqualify a coded pixel block from transmission if the coded pixel block failed to meet one of two requirements—a first requirement based on JND distortion as described above and a second requirement based on another restriction.

While the invention has been described in detail above with reference to some embodiments, variations within the scope and spirit of the invention will be apparent to those of ordinary skill in the art. Thus, the invention should be considered as limited only by the scope of the appended claims.

What is claimed is:

1. A method comprising:
coding an original pixel block into a plurality of coded pixel blocks using a variety of coding techniques;
determining a distortion value for each coded pixel block wherein the distortion value represents Just Noticeable Difference distortion of the coded pixel block upon decoding;
discarding any coded pixel block with the distortion value above an acceptable threshold value; and
selecting a coded pixel block from the remaining coded pixel blocks for output to a transmission channel.

2. The method of claim 1 further comprising selecting a subset of known coding techniques to comprise the variety of coding techniques.

3. The method of claim 1 wherein the variety of coding techniques includes coding according to a variety of prediction types.

4. The method of claim 1 further comprising discarding any coded pixel block that does not satisfy a predetermined metric.

5. The method of claim 4 wherein the predetermined metric is a bit rate of the respectively coded pixel blocks.

6. The method of claim 4 wherein the predetermined metric is a mean square error distortion value of the respectively coded pixel blocks.

7. The method of claim 4 wherein the predetermined metric is a decode complexity induced at a decoder by the respective coding techniques.

8. The method of claim 4 wherein the predetermined metric is a resilience to transmission errors of the respectively coded pixel blocks.

9. The method of claim 4 wherein the predetermined metric is a minimum viewing distance of the respectively coded pixel blocks.

10. The method of claim 4 wherein more than one predetermined metric is used to discard the coded pixel block.

11. The method of claim 4 wherein the predetermined metric changes dynamically.

12. A method comprising:
coding an original pixel block into a plurality of coded pixel blocks using a variety of coding techniques;
determining a minimum viewing distance value for which each coded pixel block has an acceptable distortion value, wherein the distortion value represents Just Noticeable Difference distortion of the coded pixel block upon decoding;
discarding any coded pixel block with the minimum viewing distance value above an acceptable threshold value; and
selecting a coded pixel block from the remaining coded pixel blocks for output to a transmission channel.

13. The method of claim 12 further comprising selecting a subset of known coding techniques to comprise the variety of coding techniques.

14. The method of claim 12 further comprising discarding any coded pixel block that does not meet a predetermined metric.

15. The method of claim 14 wherein more than one predetermined metric is used to discard the coded pixel block.

16. The method of claim 14 wherein the predetermined metric changes dynamically.

17. A system comprising:
a coding engine to convert an input video data into a plurality of coded pixel blocks using a variety of coding techniques; and
a controller to determine a distortion value of each coded pixel block, to discard any coded pixel blocks with the distortion value above a predetermined threshold value, and to select a coded pixel block for transmission from the plurality of remaining coded pixel blocks, wherein the distortion value represents Just Noticeable Difference distortion of the coded pixel block upon decoding.

18. The system of claim 17 wherein the coding engine selects a subset of known coding techniques to comprise the variety of coding techniques.

19. The system of claim 17 wherein the controller discards any coded pixel block that does not meet a predetermined metric.

20. The system of claim 19 wherein more than one predetermined metric is used to discard the coded pixel block.

21. The system of claim 19 wherein the predetermined metric changes dynamically.

22. A system comprising:
a coding engine to convert input video data into a plurality of coded pixel blocks using a variety of coding techniques; and
a controller to determine a minimum viewing distance value for which each coded pixel block has an acceptable distortion value, to discard any coded pixel blocks with the minimum viewing distance value above a predetermined threshold value, and to select a coded pixel block for transmission from the plurality of remaining coded pixel blocks, wherein the distortion value represents Just Noticeable Difference distortion of the coded pixel block upon decoding.

23. The system of claim 22 wherein the coding engine selects a subset of known coding techniques to comprise the variety of coding techniques.

24. The system of claim 22 wherein the controller discards any coded pixel block that does not meet a predetermined metric.

25. The system of claim 24 wherein more than one predetermined metric is used to discard the coded pixel block.

26. The system of claim 24 wherein the predetermined metric changes dynamically.

27. A computer-readable medium encoded with a computer-executable program to perform a method comprising:
coding an original pixel block into a plurality of coded pixel blocks using a variety of coding techniques;
determining a distortion value for each coded pixel block wherein the distortion value represents Just Noticeable Difference distortion of the coded pixel block upon decoding;
discarding any coded pixel block with the distortion value above a predetermined threshold value; and
selecting a coded pixel block from the remaining coded pixel blocks for output to a transmission channel.

28. The computer-readable medium of claim 27 further comprising selecting a subset of known coding techniques to comprise the variety of coding techniques.

29. The computer-readable medium of claim 27 further comprising discarding any coded pixel block that does not satisfy a predetermined metric.

30. The computer-readable medium of claim 29 wherein more than one predetermined metric is used to discard the coded pixel block.

31. The computer-readable medium of claim 29 wherein the predetermined metric changes dynamically.

32. A computer-readable medium encoded with a computer-executable program to perform a method comprising:
coding an original pixel block into a plurality of coded pixel blocks using a variety of coding techniques;
determining a minimum viewing distance value for which each coded pixel block has an acceptable distortion value, wherein the distortion value represents Just Noticeable Difference distortion of the coded pixel block upon decoding;
discarding any coded pixel block with the minimum viewing distance value above a predetermined threshold value; and
selecting a coded pixel block from the remaining coded pixel blocks for output to a transmission channel.

33. The computer-readable medium of claim 32 further comprising selecting a subset of known coding techniques to comprise the variety of coding techniques.

34. The computer-readable medium of claim 32 further comprising discarding any coded pixel block that does not satisfy a predetermined metric.

35. The computer-readable medium of claim 34 wherein more than one predetermined metric is used to discard the coded pixel block.

36. The computer-readable medium of claim 34 wherein the predetermined metric changes dynamically.

37. A method comprising:
coding an original pixel block into a plurality of coded pixel blocks using a variety of coding techniques;
determining a minimum viewing distance value for which each coded pixel block has an perceptible distortion value;
discarding any coded pixel block with the minimum viewing distance value above an acceptable threshold value; and
selecting a coded pixel block from the remaining coded pixel blocks for output to a transmission channel.
